(19) United States
(12) Patent Application Publication
(10) Pub. No.: US 2026/0082313 A1
(43) Pub. Date: Mar. 19, 2026

(54) Acknowledgement Management for Coordinated Access Points

(71) Applicant: Telefonaktiebolaget LM Ericsson (publ), Stockholm (SE)

(72) Inventors: Charlie Pettersson, Solna (SE); Abhishek Ambede, Huddinge (SE); Leif Wilhelmsson, Lund (SE); Sebastian Max, Cologne (DE); Rocco Di Taranto, Lund (SE)

(21) Appl. No.: 19/109,010

(22) PCT Filed: Sep. 6, 2022
(86) PCT No.: PCT/EP2022/074718

§ 371 Date: Mar. 5, 2025

(51) Int. Cl. H04W 48/16

(52) U.S. Cl. CPC H04W 48/16

(57) ABSTRACT

An access point (10) of the wireless communication system performs one or more first wireless transmissions to one or more wireless devices (11) associated with the access point (10). The first wireless transmissions are coordinated with one or more second wireless transmissions of at least one other access point (10) of the wireless communication system. For at least one of the one or more first wireless transmissions, the access point (10) receives an acknowledgement message comprising first acknowledgement information indicating whether the first wireless transmission was successfully received. The acknowledgement message is based on a retransmission mechanism which controls retransmission of the first acknowledgement information.

### TECHNICAL FIELD

The present invention relates to methods for controlling wireless transmissions and to corresponding devices, systems, and computer programs.

### BACKGROUND

Wireless communication technologies may use licensed frequency bands and/or license-exempt frequency bands. A typical example of a wireless communication technology operating in license-exempt frequency bands is the WLAN (Wireless Local Area Network) technology, according to “IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications,” in IEEE Std 802.11-2020 (Revision of IEEE Std 802.11-2016), pp. 1-4379, 26 Feb. 2021, in the following denoted as “IEEE 802.11 Standard”. The WLAN technology based on the IEEE 802.11 Standard is also referred to as “Wi-Fi”.

One recently considered approach in IEEE 802.11 standardization for improving efficiency and performance of the WLAN technology is cooperation of multiple access points (APs), which is also denoted as multi-AP cooperation. In the case of multi-AP cooperation, APs in close proximity of each other may exchange information with the aim of increasing overall efficiency of the network. The efficiency may be increased by either performing cooperative transmissions or by cooperative management such as using joint settings for a virtual carrier-sensing mechanism, e.g., the NAV (Network Allocation Vector) of the IEEE 802.11 Standard, or by performing handovers. Cooperative transmissions may for example be based on coordinated orthogonal frequency division multiple access (C-OFDMA), coordinated time division multiple access (C-TDMA), coordinated spatial reuse (CSR), coordinated beamforming (CBF), or joint transmissions (JT).

A further feature of the WLAN technology is the usage of block acknowledgements (BAs) to provide feedback on success or failure of wireless transmissions. The BAs are used on the MAC (Medium Access Control) layer and indicate which MPDUs (MAC Protocol Data Unit) were successfully received and to allow for retransmissions in the case of complete or partial reception failure. A wireless device, in the WLAN technology denoted as STA (station), is allowed to wait for a certain time before acknowledging of MPDUs. The STA may thus first receive a larger amount of MPDUs and then send an acknowledgement for all these MPDUs in a single message, denoted as BA. The usage of BAs may provide higher efficiency than sending a dedicate acknowledgement (ACK) for each MPDU.

There are a couple of different variants that are allowed when using BA which can generally be divided into implicit and explicit procedures. An implicit procedure expects a BA to be sent by the receiver STA an SIFS (Short Interframe Space) after the data is received. If the transmitter STA does not receive a BA after SIFS, it considers the data transmission as lost and will typically initiate a retransmission of the data. An explicit procedure typically uses a block ack request (BAR), sent by the transmitter STA, to trigger the BA transmission from the receiver STA. There exists both an immediate explicit variant, where the BA is sent immediately in response to the BAR, and a delayed explicit variant, in which the receiver STA first sends a dedicated ACK as a response to the BAR to indicate that the BAR was received, followed by a SIFS and a BA as in the immediate case. The BAR may also be used in the implicit variant to solicit a retransmission of the BA if it has been lost.

When using multi-AP cooperation, it may however occur that, while coordination of the actual data transmissions can be achieved without too much complexity, there may be a risk of colliding BAs. In the context of CSR, such issues are for example mentioned in IEEE contribution “Coordinated Spatial Reuse Procedure”, by S. Park et al., document IEEE 802.11-20/0410r4, available from the Internet under “https://mentor.ieee.org/802.11/dcn/20/11-20-0410-04-00be-coordinated-spatial-reuse-procedure.pptx” (March 2020) and in IEEE contribution “Coordinated Spatial Reuse: Focus on Downlink”, by Han et al., document IEEE 802.11-20/0590r5, available from the Internet under “https://mentor.ieee.org/802.11/dcn/20/11-20-0590-05-00be-shared-txop-spatial-reuse-considerations.pptx”(May 2020).

Failure in BA reception due to bad channel conditions, interference or other reasons typically triggers a retransmission of all the MPDUs already transmitted. Such retransmission can become increasingly costly in a multi-AP coordinated scenario if multiple APs or associated STAs need to perform retransmissions on shared resources. In some cases, such retransmission of MPDUs might not even be required when all the MPDUs were successfully received, but the BA was lost. Since the number of MPDUs that can be acknowledged in a single BA could be as high as 2048 in the upcoming EHT technology, as for example described in IEEE draft “IEEE P802.11be/D2.0” (May 2022), the cost of losing a BA may be significant.

Accordingly, there is a need for techniques which allow for handling acknowledgement information of coordinated transmissions in an efficient manner.

### SUMMARY

According to an embodiment, a method of controlling wireless transmissions in a wireless communication system is provided. According to the method, an access point of the wireless communication system performs one or more first wireless transmissions to one or more wireless devices associated with the access point. The first wireless transmissions are coordinated with one or more second wireless transmissions of at least one other access point of the wireless communication system. For at least one of the one or more first wireless transmissions, the access point receives an acknowledgement message comprising first acknowledgement information indicating whether the first wireless transmission was successfully received. The acknowledgement message is based on a retransmission mechanism which controls retransmission of the first acknowledgement information.

According to a further embodiment, an access point for a wireless communication system is provided. The access point is configured to perform one or more first wireless transmissions to one or more wireless devices associated with the access point. The first wireless transmissions are coordinated with one or more second wireless transmissions of at least one other access point of the wireless communication system. Further, the access point is configured to, for at least one of the one or more first wireless transmissions, receive an acknowledgement message comprising first acknowledgement information indicating whether the first wireless transmission was successfully received. The acknowledgement message is based on a retransmission mechanism which controls retransmission of the first acknowledgement information.

According to a further embodiment, an access point for a wireless communication system is provided. The access point comprises at least one processor and a memory. The memory contains instructions executable by said at least one processor, whereby the access point is operative to perform one or more first wireless transmissions to one or more wireless devices associated with the access point. The first wireless transmissions are coordinated with one or more second wireless transmissions of at least one other access point of the wireless communication system. Further, the memory contains instructions executable by said at least one processor, whereby the access point is operative to, for at least one of the one or more first wireless transmissions, receive an acknowledgement message comprising first acknowledgement information indicating whether the first wireless transmission was successfully received. The acknowledgement message is based on a retransmission mechanism which controls retransmission of the first acknowledgement information.

According to a further embodiment, a computer program or computer program product is provided, e.g., in the form of a non-transitory storage medium, which comprises program code to be executed by at least one processor of an access point of a wireless communication system. Execution of the program code causes the access point to perform one or more first wireless transmissions to one or more wireless devices associated with the access point. The first wireless transmissions are coordinated with one or more second wireless transmissions of at least one other access point of the wireless communication system. Further, execution of the program code causes the access point to, for at least one of the one or more first wireless transmissions, receive an acknowledgement message comprising first acknowledgement information indicating whether the first wireless transmission was successfully received. The acknowledgement message is based on a retransmission mechanism which controls retransmission of the first acknowledgement information.

Details of such embodiments and further embodiments will be apparent from the following detailed description.

### BRIEF DESCRIPTION OF THE DRAWINGS

FIG. 1 schematically illustrates a wireless communication system according to an embodiment.

FIG. 2 schematically illustrates processes for triggering retransmission of acknowledgement information according to an embodiment.

FIG. 3 schematically illustrates an example of a scenario involving usage of reception-beamforming for receiving acknowledgement information according to an embodiment.

FIG. 4 schematically illustrates processes for controlling reception-beamforming for receiving acknowledgement information according to an embodiment.

FIG. 5 schematically illustrates a further example of a scenario involving relaying of acknowledgement information according to an embodiment.

FIG. 6 shows a flowchart for schematically illustrating a method according to an embodiment.

FIG. 7 schematically illustrates structures of an access point according to an embodiment.

### DETAILED DESCRIPTION

In the following, concepts in accordance with exemplary embodiments of the invention will be explained in more detail and with reference to the accompanying drawings. The illustrated embodiments relate to controlling of wireless transmissions in a wireless communication system. The wireless communication system may be a WLAN system based on a IEEE 802.11 technology. However, it is noted that the illustrated concepts could also be applied to other wireless communication technologies, e.g., to contention-based modes of the LTE (Long Term Evolution) or NR (New Radio) technology specified by 3GPP (3^{rd} Generation Partnership Project).

According to the illustrated concepts, APs coordinate their wireless transmissions, e.g., by using C-OFDMA, C-TDMA, CSR, CBF, or JT. The APs may contend for access to the wireless medium and, in response to gaining access to the wireless medium, share a transmit opportunity (TXOP). In the following, the AP which gained access to the wireless medium and reserved the TXOP will also be referred to as “sharing AP”. The coordinated wireless transmissions may then be performed in the TXOP. The coordinated wireless transmissions may involve that each AP sends wireless transmissions to its associated wireless devices, in the following denoted as STAs. The STAs in turn acknowledge successful reception of the wireless transmission by sending acknowledgement messages. The acknowledgement messages may correspond to BAs which each acknowledge multiple MPDUs. However, other types of acknowledgement messages could be used as well, e.g., a dedicated acknowledgement message relating to a single MPDU or other type of data unit. The acknowledgement messages are managed based on a retransmission mechanism which controls retransmission of acknowledgement information conveyed by the acknowledgement messages. Accordingly, if a certain acknowledgement message is lost, the retransmission mechanism may trigger a retransmission of the acknowledgement information conveyed by this message. The retransmission mechanism may operate in a manner which is coordinated among the APs. For example, one of the APs may exchange information with one or more of the other APs and control retransmissions of the acknowledgement information for its wireless transmissions based on the exchanged information. Further, the APs may use receive beamforming for receiving wireless transmissions carrying the acknowledgement information. Further, the APs may share received acknowledgement information. For example, if one of the APs receives acknowledgement information relating to a wireless transmission of another AP, the AP can share this information with the other AP. The other AP may use this information as input to the retransmission mechanism or even directly to reconstruct an acknowledgement message which was not correctly received.

Accordingly, in the illustrated concepts BAs of cooperating APs can be handled in an efficient manner by using BA retransmissions. Further, sharing of BA information among the APs and/or or receive beamforming when receiving the BA at the AP can be utilized. The receive beamforming may allow for using the same time and frequency resources for the BA transmissions. This can be achieved without requiring transmit beamforming at the associated STAs. Excessive complexity for implementation at the STAs can thus be avoided.

The sharing AP can be responsible for configuring the utilization of BA retransmissions, sharing of BA information among the APs, and/or or receive beamforming. Alternatively, the utilization of BA retransmissions, sharing of BA information among the APs, and/or or receive beamforming could be preconfigured at least in part. The sharing of BA information may be among all cooperating APs. In some cases, the BA information may be collected by a specific AP which manages the transmission and retransmission of the BAs, e.g., by the sharing AP. This AP can then also further distribute selected BA information to the other APs. The shared BA information may include an information on BA reception, on MPDU reception, on codeword reception. In some cases, also complete received BAs may be shared. The sharing of the BAs may be accomplished by wireless transmission among the APs and/or by wire-based transmissions among the APs, e.g., through a distribution system or backbone network.

As regards the retransmission mechanism, the decision whether to initiate a BA retransmission may be based on a cost of retransmitting the BA relative to retransmitting the data to which the BA relates, taking into account all affected APs. The cost can for example be assessed in terms of required occupancy time of wireless resources.

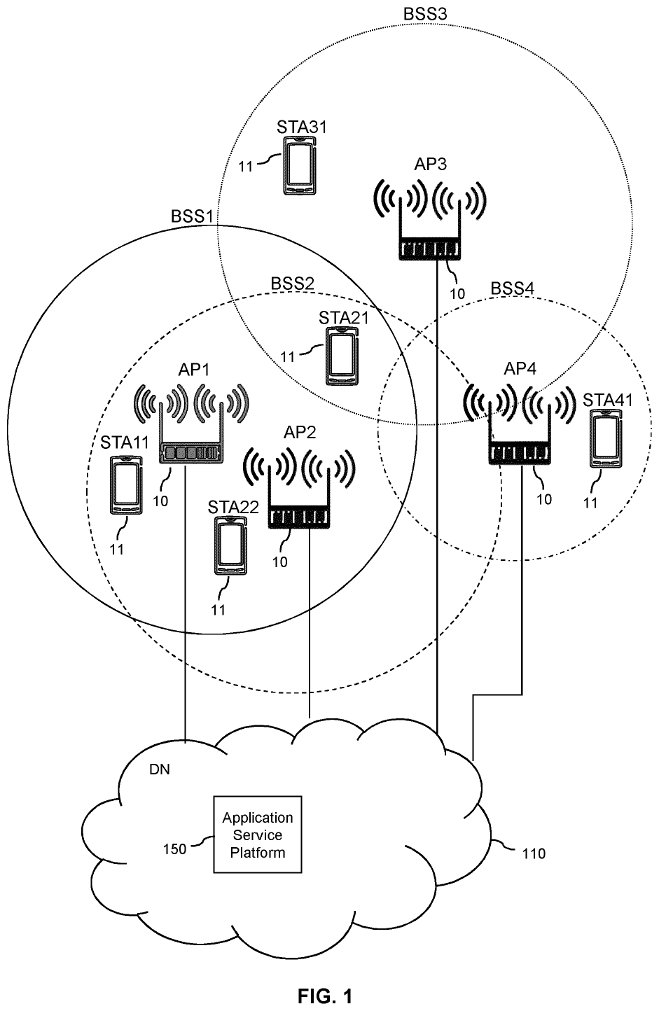

FIG. 1 illustrates an exemplary wireless communication system according to an embodiment. In the illustrated example, the wireless communication system includes multiple APs 10, in the illustrated example referred to as AP1, AP2, AP3, AP4, and multiple stations 11, in the illustrated example referred to as STA11, STA21, STA22, STA31, and STA41. STA11 is served by AP1, in a first BSS (Basic Service Set) denoted as BSS1. STA21 and STA22 are served by AP2, in a second BSS denoted as BSS2. STA31 is served by AP3, in a third BSS denoted as BSS3. STA41 is served by AP4, in a fourth BSS denoted as BSS4. The stations 11 may be non-AP STAs and correspond to various kinds of wireless devices, for example user terminals, such as mobile or stationary computing devices like smartphones, laptop computers, desktop computers, tablet computers, gaming devices, or the like. Further, the stations 11 could for example correspond to other kinds of equipment like smart home devices, printers, multimedia devices, data storage devices, or the like.

In the example of FIG. 1, each of the stations 11 may connect through a radio link to one of the APs 10. For example depending on location or channel conditions experienced by a given station 11, the station 11 may select an appropriate AP 10 and BSS for establishing the radio link. The radio link may be based on one or more OFDM carriers from a frequency spectrum which is shared on the basis of a contention based mechanism, e.g., an unlicensed or license-exempt band like the 2.4 GHz ISM band, the 5 GHz band, the 6 GHz band, or the 60 GHz band.

Each AP 10 may provide data connectivity of the stations 11 connected to the AP 10. As further illustrated, the APs 10 may be connected to a data network (DN) 110. In this way, the APs 10 may also provide data connectivity between stations 11 connected to different APs 10. Further, the APs 10 may also provide data connectivity of the stations 11 to other entities, e.g., to one or more servers, service providers, data sources, data sinks, user terminals, or the like. Accordingly, the radio link established between a given station 11 and its serving AP 10 may be used for providing various kinds of services to the station 11, e.g., a voice service, a multimedia service, or other data service. Such services may be based on applications which are executed on the station 11 and/or on a device linked to the station 11. By way of example, FIG. 1 illustrates an application service platform 150 provided in the DN 110. The application(s) executed on the station 11 and/or on one or more other devices linked to the station 11 may use the radio link for data communication with one or more other stations 11 and/or the application service platform 150, thereby enabling utilization of the corresponding service(s) at the station 11.

In the illustrated concepts, at least some of the APs 10 may cooperate in the wireless transmissions from the APs 10 to their respective associated stations 11. This cooperation may be based on shared usage of a TXOP reserved by one of the cooperating stations 10. The resources of the TXOP may be shared by C-OFDMA, C-TDMA, CSR, CBF, or JT. The stations 11 respond with acknowledgement information for the wireless transmissions. The acknowledgement information indicates whether data conveyed by the wireless transmissions was successfully received. In the following, it is assumed that the acknowledgement information is conveyed in the form of BA messages that may carry acknowledgement information for multiple wireless transmissions, e.g., for multiple MPDUs. However, it is noted that the illustrated concepts could be applied in a corresponding manner to other types of acknowledgement messages, e.g., to dedicated ACKs. In accordance with the illustrated concepts, the transmission of the BA messages is based on a retransmission mechanism. If acknowledgement information for a certain wireless transmission is missing, e.g., because it is not received by the AP 10 within a certain time window, the retransmission mechanism may decide whether to trigger a retransmission of the acknowledgement information or to trigger a retransmission of the data conveyed by the wireless transmission. The decision may be based on the cost of the retransmission of the acknowledgement information as compared to the cost of the retransmission of the data. The cost may for example be considered in terms of an occupancy duration of the wireless medium required for performing the respective retransmission.

In addition, the cooperating APs 10 may exchange information related to the BA messages. The exchanged information may include at least a part of the acknowledgement information received by the APs 10. For example, one of the cooperating APs 10 could receive acknowledgement information sent by the stations 11 associated to another of the cooperating APs 10 and then indicate this acknowledgement information to the other AP 10. In some cases, the acknowledgement information can be transmitted explicitly, e.g., by forwarding a received BA message to the AP 10 it is intended for. In other cases, only part of the information carried in the received BA message is forwarded to the AP 10 it is intended for. In other cases, the exchanged information could merely indicate the presence of a transmitted BA message, but not the specific content of the BA message. The cooperating APs 10 may use the exchanged information as input to the retransmission mechanism.

Further, the reception of the BA messages at the cooperating APs 10 may be based on receive beamforming. The APs 10 may thus receive BA messages on beams directed towards their associated stations 11 and/or place beamforming nulls in direction of stations 11 associated with the other cooperating APs 10.

In the assumed case of using BA messages for conveying the acknowledgement information to the cooperating APs 10, different scenarios may occur. In some cases, an AP 10 may receive a BA message from an associated station 11 for a set of MPDUs transmitted to the station 11, with the BA message including an acknowledgement information bitmap with all bits set to 1, indicating successful reception of all MPDUs. In other cases, some bits in the bitmap may be set to 0 indicating that there were errors in reception of the corresponding MPDUs. Such reception error can be due to the station 11 not having received the respective MPDUs or due to an error in receiving the BA message. In some scenarios, it could however happen that the AP 10 completely fails to receive the BA message.

In the illustrated concepts, effectivity of the BA message can be improved by using the retransmission mechanism, which triggers retransmissions of BA messages or the included acknowledgement information in a smart manner. Further improvements can be achieved by using receive beamforming for receiving the BA messages at the respective AP 10, thereby allowing to use the same time-frequency resources for transmission of BA messages to different cooperating APs 10, so that the acknowledgement information can be reported in a spectrally efficient manner. Still further improvements can be achieved by the sharing of information related to the BA messages among the cooperating APs 10.

In some situations it may be more efficient to retransmit a BA message rather than to retransmit the data conveyed by the wireless transmissions to which the BA message relates. This may be efficiently considered by the retransmission mechanism of the claimed solution. In practical situations, BA agreements may be set up for each traffic flow, and the type of BA procedure may vary even for a single user. Accordingly, it is beneficial if the cooperating APs 10 consider and select appropriate users that may participate in the coordinated wireless transmissions based on the BA procedure that the sharing AP 10 decides to use. The BA procedures applied by the cooperating APs may be aligned, e.g., with the aim of synchronizing timing of the BA messages. The decision whether to allow retransmission of BA messages and how to perform the retransmissions of the BA messages may be configured in a setup phase of the multi-AP cooperation, at the beginning of the shared TXOP. The decision and/or configuration may be accomplished by the sharing AP 10. The cooperating APs 10 may reuse such configuration for multiple consecutive shared TXOPs. Such reuse may also be controlled by the sharing AP.

The decision whether or not to allow retransmission of BA messages may be based on expected duration of the retransmission of the BA message in comparison to the duration of retransmission of the corresponding data. Here, it is noted that the retransmission mechanism of the illustrated concepts may take this decision taking into consideration all cooperating APs 10, e.g., by taking into account that when triggering retransmission of a BA message, typically the BA messages will need to be retransmitted for all cooperating APs 10, and when triggering retransmission of the data, typically all cooperating APs 10 will need to retransmit their data.

In the retransmission mechanism of the illustrated concepts, the sharing AP 10 may be responsible for triggering retransmission of BA messages. In some cases, responsibility for triggering retransmission of BA messages could also be assigned to another one of the cooperating APs 10, e.g., based on an agreement during a setup phase of the multi-AP cooperation, at the beginning of the shared TXOP.

In the following operation of the retransmission mechanism will be explained in more detail and with reference to specific examples. In these examples, it is assumed that the sharing AP is responsible for configuring and triggering the retransmission of BA messages. In these examples, the sharing AP 10 may accomplish the control of the retransmission of the BA messages by triggering the shared APs 10 to initiate retransmission of a BA message. For this purpose, the sharing AP 10 may first request the shared APs 10 for information on their BA status, so that the sharing AP 10 knows the BA reception status of the shared APs 10. The sharing AP 10 may issue such request based on its own BA reception status, e.g., in response to the sharing AP 10 not having received an expected BA message. The sharing AP 10 may also issue such request based on suspicion that there could be lost BA messages in the BSSs of the shared APs 10. Based on the requested information, the sharing AP 10 may decide to trigger a retransmission of BA messages by first sending a short message to the shared APs 10. This short message may indicate time duration and frequency resources, e.g., in terms of RUs (Resource Units) for each BSS. Then, each of the cooperating APs 10 sends a BAR to its associated stations 11, thereby triggering retransmission of the BA messages by the stations.

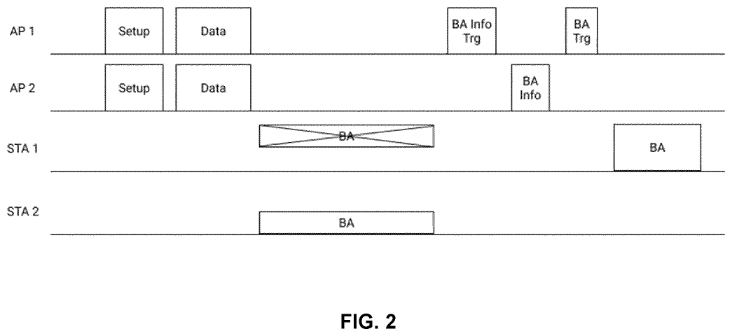

FIG. 2 illustrates an example of processes where the sharing AP triggers a retransmission of BA messages in the BSSs of all cooperating APs. The example of FIG. 2 assumes cooperation of two APs, denoted as AP1 and AP2. Stations associated with these cooperating APs are denoted as STA1 and STA2. These APs and stations may correspond to APs 10 and stations 11 as illustrated in FIG. 1. AP1 is assumed to be the sharing AP.

As illustrated, AP1 and AP2 initially perform setup of multi-AP cooperation, by exchanging one or more setup frames. During setup of the multi-AP cooperation the APs may for example agree on resources of the shared TXOP to be utilized by each of the cooperating APs. After the setup, the APs each transmit data on the resources of the shared TXOP. For example, AP1 can send data (one or more first MPDUs) to STA1 and AP2 can send data (one or more second MPDUs) to STA2. In response to successfully receiving the MPDUs from AP1, STA1 sends a BA to AP1. In response to successfully receiving the MPDUs from AP2, STA2 sends a BA to AP2. In the illustrated example, the BA to AP1 and the BA to AP2 are transmitted in a time-synchronized and frequency multiplexed manner. Specifically, the BA to AP1 is sent on a first RU and the BA to AP2 is sent on a second RU, which does not overlap with the first RU.

In the example of FIG. 2, the BA from STA1 is however not received by AP1. Accordingly, AP1 requests the BA reception status from AP2, by sending short message denoted as “BA Info Trg”. In response, AP2 sends a short message indicating its BA reception status, by sending a short message denoted as “BA Info”. In the illustrated example, the BA Info message indicates that AP2 received a BA for its data. Based on that information, AP1 triggers a retransmission of the BA from STA1, by sending a short message denoted as “BA Trg”. The latter message may for example include a BAR and an indication of resources to be used for transmission of the BA. Since AP1 is aware that AP2 successfully received its BA, it can allocate all available frequency resources, i.e., both the first RU and the second RU to the retransmission of the BA by STA1, so that likelihood of successful retransmission of the BA can be improved, e.g., by allowing to spread the retransmission over a higher bandwidth so that it requires a shorter transmit duration and/or becomes more robust to interference. In some cases also duplication of the retransmission over both RUs could be used.

In other scenarios, the sharing AP 10 could preconfigure opportunities where retransmission of a BA message is allowed to be initiated by the shared APs. In such case, the sharing AP could for example indicate during the setup phase of the multi-AP cooperation to the shared APs on which time and frequency resources the shared APs are allowed to initiate a retransmission of a BA.

In some scenarios, the sharing AP could also decide to selectively deactivate the retransmission mechanism. The above-described retransmission procedure could thus be used optionally and activated only in cases where channel or interference conditions are expected to be challenging so that there is an excessive risk of failures or errors in reception of BA messages.

As mentioned above, in some scenarios receive beamforming may be used by the cooperating APs to receive BA messages. Receive beamforming may use a precoder at the receiver side in order to spatially filter out incoming transmissions. This is helpful since it may reduce incoming interference from directions that are not part of the transmission to be received. Using receive beamforming, it is possible to achieve spatial reuse by allowing multiple simultaneous transmissions in the same time-frequency resources. In the illustrated concepts, the receive beamforming at the cooperating APs may be based on calibration of a transmit (Tx) radio chain and a receive (Rx) radio chain of the AP. If the Rx radio chain and the Tx radio chain are calibrated such that the phases of each radio chain are the same, a precoder of the Tx radio chain may be applied as a “postcoder” in the Rx radio chain to suppress interference on received signals. In the illustrated concepts, the precoder may be applied in a selective manner only when attempting to receive BA messages during multi-AP cooperation. In this way, there is no excessive risk of missing other potentially relevant transmissions, such as transmissions from other devices which could set a NAV. Accordingly, the receive beamforming may be applied in a selective manner to reduce interference among BA transmissions to the cooperating BAs.

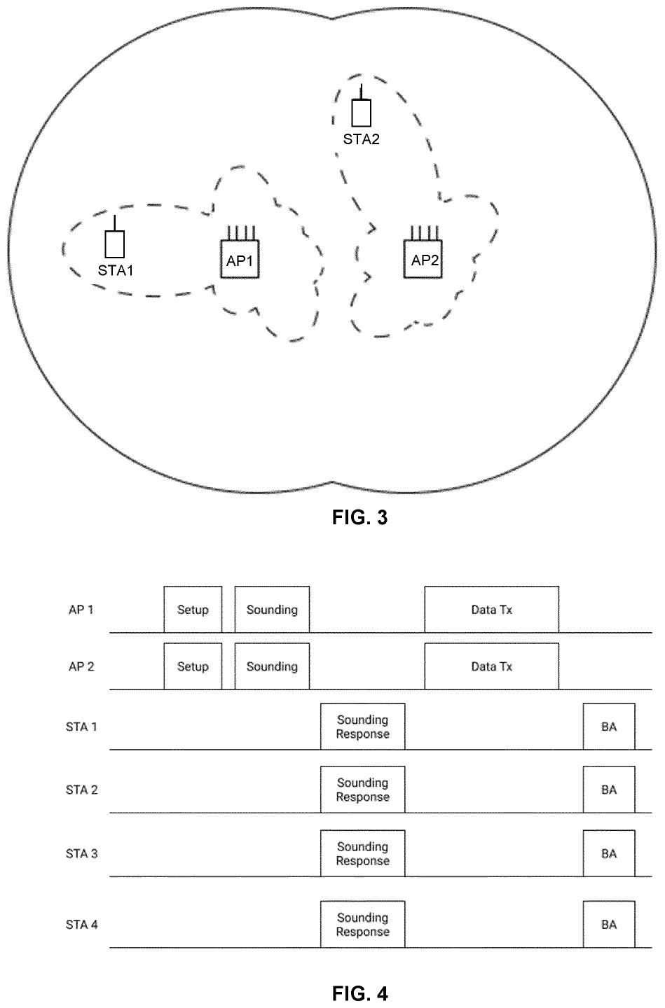

FIG. 3 schematically illustrates an exemplary scenario in which receive beamforming may be applied to reduce interference among BA transmissions to the cooperating APs. The example of FIG. 3 assumes cooperation of two APs, denoted as AP1 and AP2. Stations associated with these cooperating APs are denoted as STA1 and STA2. These APs and stations may correspond to APs 10 and stations 11 as illustrated in FIG. 1. AP1 is assumed to be the sharing AP. Broken lines indicate a receive beamforming pattern applied by each of the APs. As can be seen, the receive beamforming pattern of AP1 has maximum gain in the direction of STA1 and has minimum gain in the direction of STA2. Similarly, the receive beamforming pattern of AP2 maximizes gain toward STA2 and minimizes gain toward STA1. During the shared TXOP, the receive beamforming pattern may be applied when the APs each attempt to receive a BA message, so that interference among the BA message to AP1 and the BA message to AP2 can be avoided or reduced.

FIG. 4 illustrates an example of processes which may be used to control the receive beamforming. The example of FIG. 4 assumes cooperation of two APs, denoted as AP1 and AP2. Stations associated with these cooperating APs are denoted as STA1, STA2, STA3, and STA4. STA1 and STA2 could be associated with AP1, while STA3 and STA4 could be associated with AP2. These APs and stations may correspond to APs 10 and stations 11 as illustrated in FIG. 1. AP1 is assumed to be the sharing AP.

As illustrated, AP1 and AP2 initially perform setup of multi-AP cooperation, by exchanging one or more setup frames. During setup of the multi-AP cooperation the APs may for example agree on resources of the shared TXOP to be utilized by each of the cooperating APs. After the setup, the APs and the stations perform channel sounding to determine the channel coefficients between the APs and stations. In the illustrated example, the sounding phase involves that each of the APs sends a sounding signal, and the stations each respond with a sounding response which is based on the received sounding signals. The sounding responses may be sent to all APs, so that each AP also becomes aware of the channel conditions towards the stations served by the other AP. Based on the received sounding responses, the APs can set their receive beamforming pattern accordingly, e.g., in such a way that the receive beamforming pattern of AP1 will maximize gains toward the stations associated with AP1 and minimize the gains toward stations associated with AP2 and the receive beamforming pattern of AP2 will maximize the gains toward the stations associated with AP2 and minimize the gains toward the stations associated with AP1.

After the sounding phase, the APs each transmit data on the resources of the shared TXOP. For example, AP1 can send data (one or more first MPDUs) to STA1 and STA2, and AP2 can send data (one or more second MPDUs) to STA3 and STA4. In response to successfully receiving the MPDUs from AP1, STA1 and STA2 each sends a BA to AP1. In response to successfully receiving the MPDUs from AP2, STA3 and STA 4 each send a BA to AP2. In the illustrated example, the BAs to AP1 and the BAs to AP2 are transmitted on the same time-frequency resources. Due to the receive beamforming at the APs there is still no excessive interference, so that the BAs can be successfully received. It is noted that the information gathered in the sounding phase may also be used for other beamforming processes, e.g., for managing beamforming of the data transmissions from the APs to their associated stations.

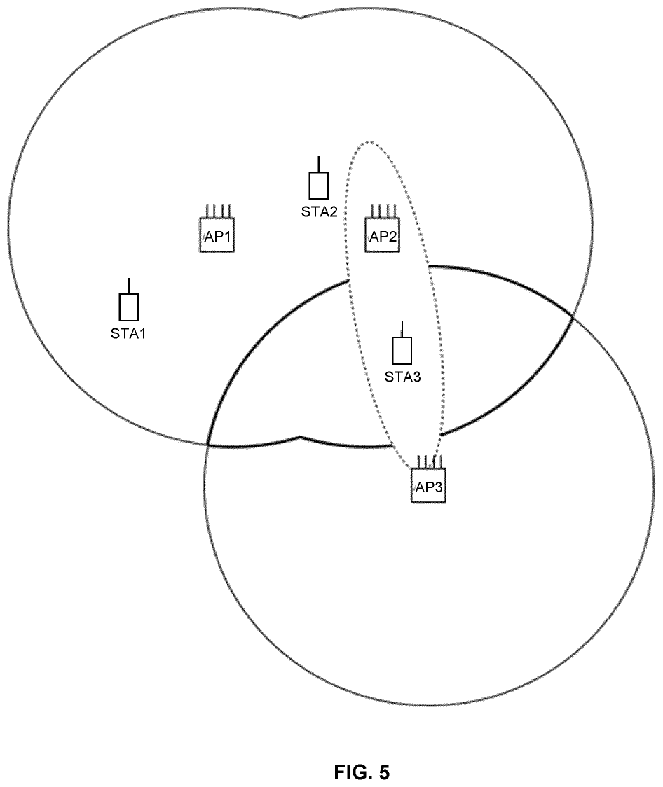

In cooperation of multiple APs like assumed in the illustrated concepts, there is typically some overlap of the BSSs of the cooperating APs. Such overlap may have the effect that a BA message sent to one of the cooperating APs could be overhead by another of the cooperating APs. Further, it could also occur that the intended recipient of the BA message is affected by interference while the AP which overhears the BA message is able to receive the BA message without excessive interference. FIG. 5 illustrates an example of a corresponding scenario.

The example of FIG. 5 assumes cooperation of two APs, denoted as AP1 and AP2. Stations associated with these cooperating APs are denoted as STA1 and STA2. Further, there is a nearby AP, denoted as AP3, with an associated station, denoted as STA3. These APs and stations may correspond to APs 10 and stations 11 as illustrated in FIG. 1. AP1 is assumed to be the sharing AP.

In the example of FIG. 5, AP3 performs a beamformed transmission to STA3, as illustrated by a dotted line. This transmission causes interference at AP2, but not at AP1. Accordingly, if STA2 sends a BA concurrently with the transmission from AP3 to STA3, AP2 may fail to correctly receive the BA message, while AP1 is able to receive the BA message intended for AP2. In the illustrated concepts, the reliability of the BA transmissions may be improved by relaying of received BA information. Specifically, in the example of FIG. 5 AP1 could receive the BA intended for AP2 and relay information on this BA to AP2. The relayed information could include the BA bitmap conveyed by the BA message. Such relaying of the entire BA message may for example be used if there are sufficient resources available for communication among the cooperating APs, e.g., if the APs can communicate over a wire-based DS. Alternatively or in addition, the relayed information could indicate a percentage of correctly received MPDUs of an aggregated MPDU. Alternatively or in addition, the relayed information could indicate a range of MPDUs that need to be retransmitted. Alternatively or in addition, the relayed information could indicate that at least one MPDU was successfully received, or that the BA has been received, or that data packet re-transmission is requested. Such indications could for example be provided in the form of a respective one-bit indicator. Alternatively or in addition, the relayed information could indicate information related to the presence of bursty interference during reception of the BA message.

The relayed information may be exchanged via wire-based connections, e.g., through a wire-based DS, or wirelessly. A decision whether to relay the information may either be taken by the AP which received the BA message, or the relaying of the information may be preconfigured. If the relaying is accomplished wirelessly, the relaying could for example be accomplished in response to the request of the BA reception status as explained in connection with FIG. 2. In some scenarios, the relaying of the BA information could also be activated on-demand, e.g., depending on a cost of relaying the information in relation to the risk of bad reception conditions for BA messages at the intended receiver. For example, such risk could be higher when using more advanced MIMO (multiple input multiple output) techniques in the wireless communication system.

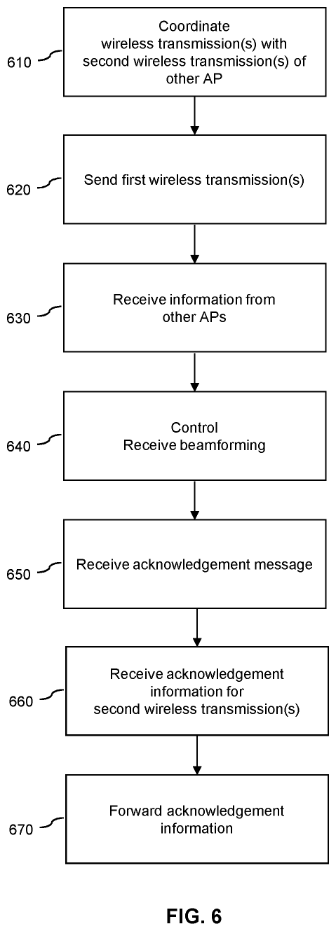

FIG. 6 shows a flowchart for illustrating a method of controlling wireless transmissions in a wireless communication system, which may be utilized for implementing the illustrated concepts. The method of FIG. 6 may be used for implementing the illustrated concepts in an AP of a wireless communication system, e.g., one of the above-mentioned APs 10. The wireless communication system may be based on a wireless local area network, WLAN, technology, e.g., according to the IEEE 802.11 standards family.

If a processor-based implementation of the AP is used, at least some of the steps of the method of FIG. 6 may be performed and/or controlled by one or more processors of the AP. Such AP may also include a memory storing program code for implementing at least some of the below described functionalities or steps of the method of FIG. 6.

At step 610, the AP coordinates one or more first wireless transmissions to one or more wireless devices associated with the AP with one or more second wireless transmissions of at least one other AP of the wireless communication system. The coordination may be based on multi-AP cooperation, e.g., C-OFDMA, C-TDMA, CSR, CBF, or JT. The coordination may for example be accomplished by signaling at the beginning of a shared TXOP. In the multi-AP cooperation, the AP may correspond to a sharing AP or to a shared AP. The one or more first wireless transmissions and the one or more second wireless transmissions may thus be coordinated in a TXOP which is reserved by one of the AP and the at least one other AP.

At step 620, the AP sends the one or more first wireless transmissions to the wireless devices. This is accomplished based on the coordination performed at step 610.

At step 630, the AP may receive information from the at least one other AP. The AP can receive the information in one or more wireless transmissions and/or in one or more wire-based transmissions.

At step 640, the AP may control receive beamforming applied at the AP. This control of the receive beamforming may be based on the information received at step 630. If the one or more first wireless transmissions and the one or more second wireless transmissions are coordinated in a TXOP which is reserved by one of the AP and the at least one other AP, the receive beamforming may be configured by the AP that reserved the TXOP. This configuration may be based on the information received at step 630. For example, the information received at step 630 could activate or deactivate the receive beamforming.

At step 650, the AP may receive an acknowledgement message for at least one of the one or more first wireless transmissions. The acknowledgement message includes first acknowledgement information indicating whether the respective first wireless transmission was successfully received. The acknowledgement message is based on a retransmission mechanism which controls retransmission of the first acknowledgement information. In some scenarios, the acknowledgement message may be a BA message which relates to a plurality of the first wireless transmissions. The retransmission of the first acknowledgement information may involve retransmission of the acknowledgement message or retransmission of a part of the first acknowledgement information conveyed by the acknowledgement message.

The retransmission mechanism may control retransmission of the first acknowledgement information based on information provided by the at least one other AP, e.g., based on the information received at step 630. The retransmission mechanism may control retransmission of the first acknowledgement information based on a cost of retransmitting the first acknowledgement information relative to a cost of retransmitting data conveyed by the at least one of the one or more first wireless transmissions.

If the one or more first wireless transmissions and the one or more second wireless transmissions are coordinated in a TXOP which is reserved by one of the AP and the at least one other AP, the retransmission mechanism may be configured by the AP that reserved the TXOP.

The AP may receive at least a part of the first acknowledgement information in at least one third wireless transmission from at least one of the wireless devices associated with the AP. The at least one third wireless transmission may be received on time frequency resources also used for transmission of second acknowledgement information for at least one of the second wireless transmissions. In some scenarios, the AP may receive the at least one third wireless transmission based on receive beamforming at the AP, e.g., as configured at step 640. The AP may then receive the at least one third wireless transmission on one or more resources shared with at least one fourth wireless transmission conveying second acknowledgement information from at least one wireless device associated with the at least one other AP.

In some scenarios, at least a part of the first acknowledgement information is provided by the at least one other AP, e.g., as explained above in connection with the forwarding of BA information. For example, the AP may receive at least a part of the first acknowledgement information in at least one further wireless transmission from the at least one other AP. Alternatively or in addition, the AP could receive at least a part of the first acknowledgement information in at least one wire-based transmission from the at least one other AP.

At step 660, the AP may receive second acknowledgement information for at least one of the one or more second wireless transmissions from at least one wireless device associated with the at least one other AP. The second acknowledgement information indicates whether the second wireless transmission was successfully received. The AP may receive the second acknowledgement information in at least one fourth wireless transmission from the at least one wireless device associated with the at least one other AP. In some scenarios, the AP may receive the at least one fourth wireless transmissions based on receive beamforming at the AP, e.g., as configured at step 640. In some scenarios, the second acknowledgement information may be received in a BA message which relates to a plurality of the second wireless transmissions.

At step 670, the AP may forward at least a part of the second acknowledgement information to the at least one other AP. For example, the AP may forward at least a part of the second acknowledgement information in at least one further wireless transmission to the at least one other AP. Alternatively or in addition, the AP could forward at least a part of the second acknowledgement information in at least one wire-based transmission from the at least one other AP.

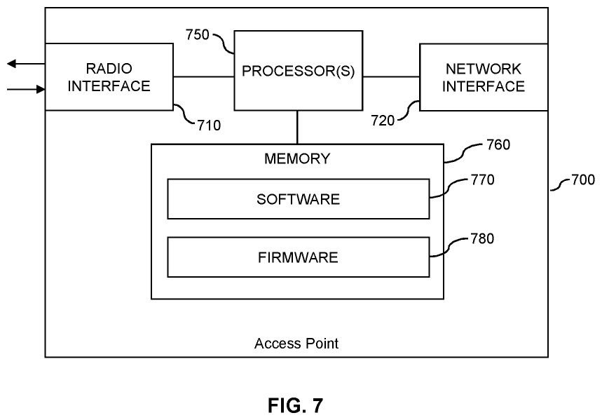

FIG. 7 illustrates a processor-based implementation of an AP 700. The structures as illustrated in FIG. 7 may be used for implementing the above-described concepts. The AP 700 may for example correspond to one of above-mentioned APs 10.

As illustrated, the AP 700 includes a radio interface 710. The radio interface 710 may for example be based on a WLAN technology, e.g., according to an IEEE 802.11 family standard. However, other wireless technologies could be supported as well, e.g., the LTE technology or the NR technology. Further, the AP 700 is provided with a network interface 720 for connecting to a data network, e.g., using a wire-based connection.

Further, the AP 700 may include one or more processors 750 coupled to the interfaces 710, 720, and a memory 760 coupled to the processor(s) 750. By way of example, the interfaces 710, 720, the processor(s) 750, and the memory 760 could be coupled by one or more internal bus systems of the AP 700. The memory 760 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 760 may include software 770 and/or firmware 780. The memory 760 may include suitably configured program code to be executed by the processor(s) 750 so as to implement the above-described functionalities for controlling wireless transmissions, such as explained in connection with the method of FIG. 6.

It is to be understood that the structures as illustrated in FIG. 7 are merely schematic and that the AP 700 may actually include further components which, for the sake of clarity, have not been illustrated, e.g., further interfaces or further processors. Also, it is to be understood that the memory 760 may include further program code for implementing known functionalities of an AP in an IEEE 802.11 technology. According to some embodiments, also a computer program may be provided for implementing functionalities of the AP 700, e.g., in the form of a physical medium storing the program code and/or other data to be stored in the memory 760 or by making the program code available for download or by streaming.

As can be seen, the concepts as described above may be used for efficiently handling acknowledgement information provided to cooperating APs. Based on the illustrated concepts, it can be achieved that loss of a BA does not automatically mean that a retransmission of the associated data needs to be performed. This in turn may help to increase throughput, reduce latency, and/or to improve energy efficiency. Furthermore, using receive beamforming for the acknowledgement information may improve better spectral efficiency. The receive beamforming for the acknowledgement information may be efficiently implemented based on reusing sounding procedures as also used for other purposes, such as CBF or JT applied for the transmissions of data. When using the receive beamforming, it may also be possible to reduce the time duration required for transmission of the acknowledgement information, so that the risk of bursty interference can be reduced.

It is to be understood that the examples and embodiments as explained above are merely illustrative and susceptible to various modifications. For example, the illustrated concepts may be applied in connection with various kinds of wireless technologies, without limitation to WLAN technologies. Further, it is noted that the above-described usage of the receive beamforming for the acknowledgement information and/or the above-described forwarding of acknowledgement information could also be used without the retransmission mechanism. The concepts may be also be applied with respect to any number of APs cooperating on the same wireless link. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1.-19. (canceled)

20. A method of controlling wireless transmissions in a wireless communication system, the method comprising:
performing, by an access point of the wireless communication system, one or more first wireless transmissions to one or more wireless devices associated with the access point, the first wireless transmissions being coordinated with one or more second wireless transmissions of at least one other access point of the wireless communication system; and
for at least one of the one or more first wireless transmissions, receiving, by the access point, an acknowledgement message comprising first acknowledgement information indicating whether the first wireless transmission was successfully received, wherein the acknowledgement message is based on a retransmission mechanism which controls retransmission of the first acknowledgement information, wherein the retransmission mechanism controls retransmission of the first acknowledgement information based on information provided by the at least one other access point.

21. The method according to claim 20, wherein the retransmission mechanism controls retransmission of the first acknowledgement information based on a cost, assessed in terms of occupancy time of wireless resources, of retransmitting the first acknowledgement information relative to a cost of retransmitting data conveyed by the at least one of the one or more first wireless transmissions.

22. The method according to claim 20, wherein the one or more first wireless transmissions and the one or more second wireless transmissions are coordinated in a transmit opportunity (TXOP) reserved by one of the access point and the at least one other access point, and wherein said retransmission mechanism is configured by the access point that reserved the TXOP.

23. The method according to claim 20, wherein the access point receives at least a part of the first acknowledgement information in at least one third wireless transmission from at least one of the wireless devices associated with the access point.

24. The method according to claim 20, wherein the at least one third wireless transmission is received on time frequency resources also used for transmission of second acknowledgement information for at least one of the second wireless transmissions.

25. The method according to claim 23, wherein the access point receives the at least one third wireless transmission based on receive beamforming at the access point.

26. The method according to claim 25, wherein the access point receives the at least one third wireless transmission on one or more resources shared with at least one fourth wireless transmission conveying second acknowledgement information from at least one wireless device associated with the at least one other access point.

27. The method according to claim 20, comprising:
for at least one of the one or more second wireless transmissions, receiving, by the access point, second acknowledgement information in at least one fourth wireless transmissions from at least one wireless device associated with the at least one other access point, the second acknowledgement information indicating whether the second wireless transmission was successfully received; and
forwarding, by the access point, the second acknowledgement information to the at least one other access point.

28. The method according to claim 27, wherein the access point receives the at least one fourth wireless transmissions based on receive beamforming at the access point.

29. The method according to claim 25, wherein the one or more first wireless transmissions and the one or more second wireless transmissions are coordinated in a transmit opportunity (TXOP) reserved by one of the access point and the at least one other access point, and wherein said receive beamforming is configured by the access point that reserved the TXOP.

30. The method according to claim 20, wherein at least a part of the first acknowledgement information is provided by the at least one other access point.

31. The method according to claim 30, wherein the access point receives at least a part of the first acknowledgement information:
in at least one fifth wireless transmission from the at least one other access point; or
in at least one wire-based transmission from the at least one other access point.

32. The method according to claim 20, wherein the wireless communication system is based on a Wireless Local Area Network technology according to the IEEE 802.11 standards family.

33. An access point for a wireless communication system, the access point comprising:
at least one processor, and
a memory containing program code executable by the at least one processor, whereby execution of the program code by the at least one processor causes the access point to:
perform one or more first wireless transmissions to one or more wireless devices associated with the access point, the first wireless transmissions being coordinated with one or more second wireless transmissions of at least one other access point of the wireless communication system; and
for at least one of the one or more first wireless transmissions, receive an acknowledgement message comprising first acknowledgement information indicating whether the first wireless transmission was successfully received, wherein the acknowledgement message is based on a retransmission mechanism which controls retransmission of the first acknowledgement information, wherein the retransmission mechanism controls retransmission of the first acknowledgement information based on information provided by the at least one other access point.

34. The access point according to claim 33, wherein the retransmission mechanism controls retransmission of the first acknowledgement information based on a cost, assessed in terms of occupancy time of wireless resources, of retransmitting the first acknowledgement information relative to a cost of retransmitting data conveyed by the at least one of the one or more first wireless transmissions.

35. The access point according to claim 33, wherein the one or more first wireless transmissions and the one or more second wireless transmissions are coordinated in a transmit opportunity (TXOP) reserved by one of the access point and the at least one other access point, and wherein said retransmission mechanism is configured by the access point that reserved the TXOP.

36. The access point according to claim 33, wherein execution of the program code by the at least one processor causes the access point to receive at least a part of the first acknowledgement information in at least one third wireless transmission from at least one of the wireless devices associated with the access point.

37. The access point according to claim 33, wherein execution of the program code by the at least one processor causes the access point to receive the at least one third wireless transmission is on time frequency resources also used for transmission of second acknowledgement information for at least one of the second wireless transmissions.

38. The access point according to claim 36, wherein execution of the program code by the at least one processor causes the access point to receive the at least one third wireless transmission based on receive beamforming at the access point.

39. The access point according to claim 38, wherein execution of the program code by the at least one processor causes the access point to receive the at least one third wireless transmission on one or more resources shared with at least one fourth wireless transmission conveying second acknowledgement information from at least one wireless device associated with the at least one other access point.

40. The access point according to claim 33, wherein execution of the program code by the at least one processor causes the access point to:
for at least one of the one or more second wireless transmissions, receive second acknowledgement information in at least one fourth wireless transmissions from at least one wireless device associated with the at least one other access point, the second acknowledgement information indicating whether the second wireless transmission was successfully received; and
forward the second acknowledgement information to the at least one other access point.

41. The access point according to claim 40, wherein execution of the program code by the at least one processor causes the access point to receive the at least one fourth wireless transmissions based on receive beamforming at the access point.

42. The access point according to claim 38, wherein the one or more first wireless transmissions and the one or more second wireless transmissions are coordinated in a transmit opportunity (TXOP) reserved by one of the access point and the at least one other access point, and wherein said receive beamforming is configured by the access point that reserved the TXOP.

43. The access point according to claim 33, wherein at least a part of the first acknowledgement information is provided by the at least one other access point.

44. The access point according to claim 43, wherein execution of the program code by the at least one processor causes the access point to receive at least a part of the first acknowledgement information:
in at least one fifth wireless transmission from the at least one other access point; or
in at least one wire-based transmission from the at least one other access point.

45. The access point according to claim 33, wherein the wireless communication system is based on a Wireless Local Area Network technology according to the IEEE 802.11 standards family.
